(19) United States
(12) Patent Application Publication
(10) Pub. No.: US 2025/0124619 A1
(43) Pub. Date: Apr. 17, 2025

(54) AUGMENTED REALITY SAFETY GLASSES

(71) Applicant: TEXTRON INC., Providence, RI (US)

(72) Inventor: Brian David WANTA, Providence, RI (US)

(21) Appl. No.: 18/485,552

(22) Filed: Oct. 12, 2023

(51) Int. Cl. G06T 11/20; A01D 34/00; A01D 101/00; G01C 17/00

(52) U.S. Cl. CPC G06T 11/203; A01D 34/006; G01C 17/00; A01D 2101/00

(57) ABSTRACT

The technology described herein relates to, among other topics, augmented reality devices and systems. In particular, the technology relates to a system for generating an augmented reality environment where an augmented reality display can be displayed (e.g., via safety glasses). The augmented reality display can include information for a user to navigate and/or operate a vehicle within a particular location, where geofencing technology can be used to establish subareas within the location.

### BACKGROUND

Augmented reality (AR) technology provides endless possibilities to integrate virtual environments into real world environments. As an example, a user can play a video game where the user is required to move to various real-world locations in order to “uncover” one or more virtual characters. Using their mobile device, the user can point the outside camera at a real-world location and using various data from the device (e.g., orientation data, location data), the mobile device can display a virtual object superimposed upon the real-world image.

Certain technology exists for a user to wear a device (e.g., glasses) in order to experience an augmented reality environment. The conventional technology is useful in allowing a user to “immerse” themselves in a real-world environment populated with various visual objects displayed by the device. However, the conventional technology is generally limited in application and generally involves simple overlay of virtual items onto a real-world image. Moreover, the conventional technology is also limited in use of geofencing technology for providing guidance as to where a user may navigate using the augmented reality technology. Additionally, conventional augmented reality technology does not currently have a useful application in certain settings (e.g., for use in maintaining a course/field).

Accordingly, it will be appreciated that new and improved techniques, systems, and processes are continually sought after.

### BRIEF DESCRIPTION OF THE DRAWINGS

The foregoing and other objects, features and/or advantages will be apparent from the following description of particular embodiments, as illustrated in the accompanying drawings in which like reference characters refer to the same parts throughout the different views. The drawings are not necessarily to scale, emphasis instead being placed upon illustrating the principles of various example embodiments. Each embodiment herein may be used in combination with any other embodiment(s) described herein.

FIGS. 1A and 1B show non-limiting example diagrams of a system 1 in which an augmented reality environment is implemented;

FIG. 2 shows a non-limiting example block diagram of components included in system 1;

FIG. 3 shows a non-limiting example block diagram of components included in server/cloud system(s) 300;

FIGS. 4A and 4B show non-limiting example flowcharts associated with system 1;

FIG. 5 depicts an “overhead” view showing a location with different sub-areas divided by one or more geofenced barriers;

FIGS. 6A-D show non-limiting example user interface(s) 600 generated by system 1; and

FIG. 7 shows a non-limiting example portal (or user interface) 700 where elements associated with system 1 can be accessed.

### DETAILED DESCRIPTION OF EXAMPLE EMBODIMENTS

### Overview

The technology described herein relates to, among other topics, augmented reality devices and systems. In particular, the technology is generally in the field of augmented reality and can be specifically implemented for augmented reality safety glasses (e.g., for golf course, or other applications).

It should be appreciated that a goal of managing the conditions of a property (e.g., a golf course) is to offer pristine conditions every day. The primary objective used to achieve this goal is to ensure the highest quality of cut every time a mower is sent out. A main goal is to ensure every blade of grass is mown to the correct height without any skips or misses. Almost every day a mower goes out with specific mowing instructions and directions and the operator is trusted to follow these instructions and mow the designated area to completion.

This technology described herein would allow operators to wear augmented reality glasses to show mow patterns, mow direction, and what has been missed/skipped while staying safe with approved personal protection equipment. The glasses would provide lines based on an integrated compass and global position system (GPS) features. The displayed lines can show the mower operator precisely where to mow and in which direction to mow. The technology can also show the exact line to ensure the exact amount of overlap of a previous line to guarantee no missed sections. A display incorporated into safety glasses can allow the operator to view all information without losing focus of the task at hand, and messages can be sent to the device (e.g., to provide additional tasks or directions while the operator is on the course).

In one non-limiting example embodiment, the technology could employ mapping of each site (e.g., golf course, baseball field, airport) to provide a layout of mowing areas at a location. The mapping would provide the size of each area and could aid in designating each area to specific equipment (e.g., mowers) such as greens, tees, fairways, or rough. After mapping, the software could be integrated into a vehicle's on-board telemetry equipment to incorporate vehicle speed, direction of travel, and current GPS location. A real-time kinematic positioning system could also be used to provide sub-centimeter accuracy in GPS location. All information can be sent to augmented reality safety glasses to be projected to the operator of the designated mower. The system can also link to a base station via cellular or Wi-Fi to provide real-time information to the operator. In doing so, the technology advantageously expands the application of augmented reality systems thus providing a technical improvement to augmented reality technology. It should be appreciated that the examples described herein are of course non-limiting, and the technology envisions a variety of applications for the described augmented reality device(s) and system(s).

In many places in this document, software modules and actions performed by software modules are described. This is done for ease of description; it should be understood that, whenever it is described in this document that a software module performs any action, the action is in actuality performed by underlying hardware components (such as a processor and a memory) according to the instructions and data that comprise the software module.

It should also be appreciated that some of the components described in the figures (and throughout any other portion of this document) may be referred to as singular or plural components. However, these descriptions are for illustration purposes and are non-limiting. For example, if a component is referred to as a system, it should be understand that the system could comprise a single component, or could be multiple components (included distributed components). Likewise, if a component is referred to as a plurality, it should be appreciated that the component may also be implemented via a single component as well.

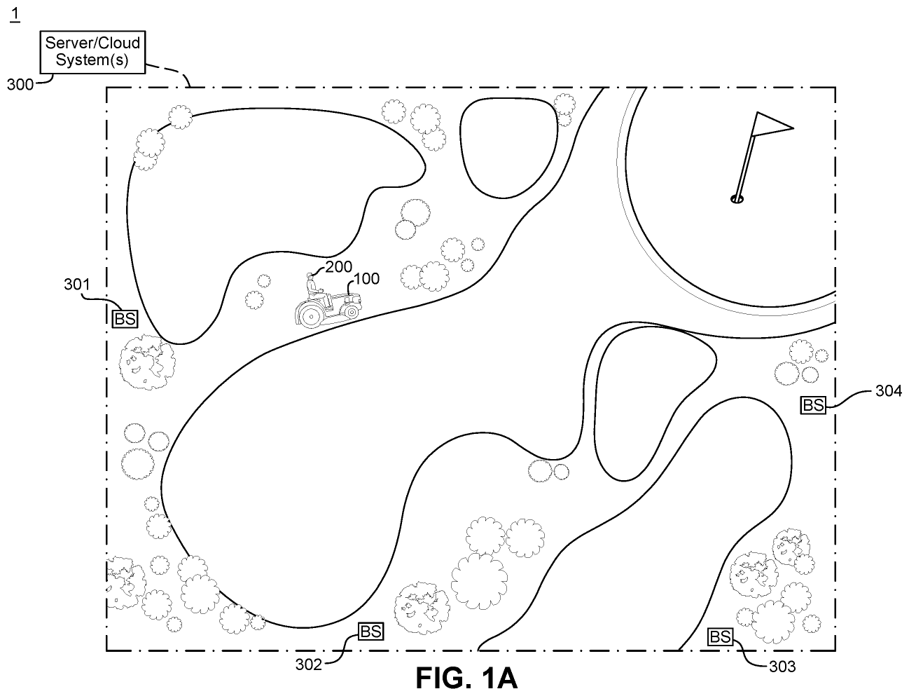

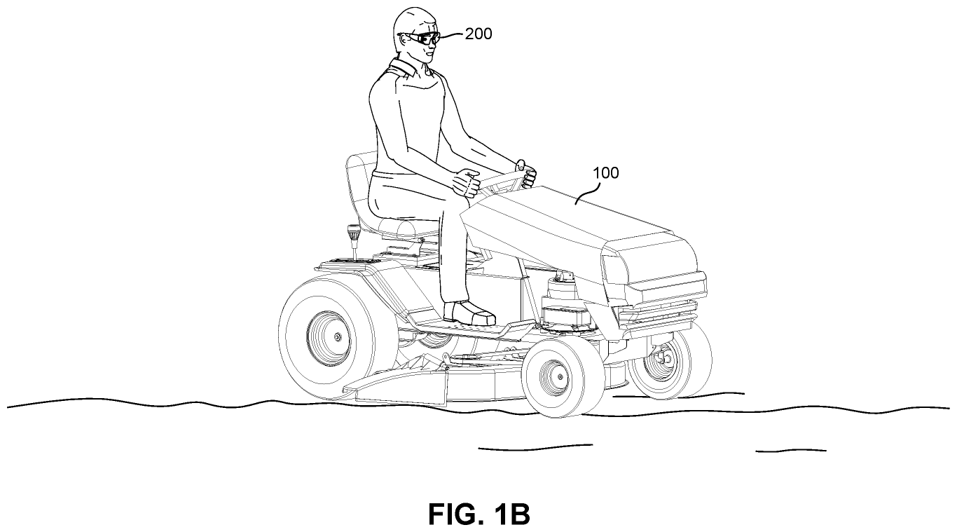

FIGS. 1A and 1B show non-limiting example diagrams of a system 1 in which an augmented reality environment is implemented. In one non-limiting example, system 1 can include various components that communicate with each other (e.g., via a network, via short distance communication). For example, system 1 may include a moving apparatus 100 and display device 200. Moving apparatus 100, in a non-limiting example embodiment, could include a lawn mower or any other equipment used for landscaping purposes. These examples are of course non-limiting and the technology describes a variety of any other type of movable device including, but not limiting to, automobiles, aircraft, bicycles, and any other type of apparatus that can move.

Display device 200, in a non-limiting example embodiment, is configured to be worn by a user. For example, display device 200 could include a pair of augmented reality glasses (e.g., safety glasses) wearable on the face of a user. While the technology described herein is generally directed to any moving apparatus and display device, the examples described in this application will be directed to lawn mower applications where the user can wear safety glasses integrating the augmented reality technology described herein.

System 1 may also include other additional components including, at least, base station(s) 301-304. Although FIG. 1A only shows four base station(s) 301-304, this is done purely for illustrative purposes and any number of base station(s) may be utilized in system 1. System 1 may also further include server (or cloud) system(s) 300 where equipment associated with moving apparatus 100 and/or display device 200 can communicate. For example, moving apparatus 100 and/or display device 200 can communicate with system(s) 300 using base station(s) 301-304. This example is of course non-limiting and moving apparatus 100 and/or display device 200 can communicate with system(s) 300 using any variety of methods including cellular/mobile data and/or Wi-Fi.

FIG. 1B shows a further non-limiting example diagram of a specific implementation of moving apparatus 100 and display device 200. In the example shown in FIG. 1B, a user sits on a riding lawn mower (e.g., as moving apparatus 100) where a pair of safety glasses (e.g., as display device 200) are worn by the user. While not shown in FIG. 1B, these components could communicate with system(s) 300 (e.g., using base station(s) 301-304). As will be described in further detail herein, the moving apparatus 100 can include an on-board computer system that includes various input/output and computing components that can be used to provide data to/from system(s) 300 in order to generate output data displayable by display device 200.

Moreover, even though the lawn mower shown in FIG. 1B depicts a riding mower, the examples described herein are not limited to such a specific embodiment, and can be applied to reel mowers and/or walking mowers (among any other mower types). For example, the user could operate a reel mower having a variety of mower reels with different blade assemblies in each reel. The computing equipment on moving apparatus 100 can thus collect data related to the moving direction, moving speed, operating state (e.g., current height of a blade deck, whether blades are currently active, which reels are currently active), and/or orientation of the apparatus 100. Such data can be used to generate an augmented reality environment that can be output using display device 200.

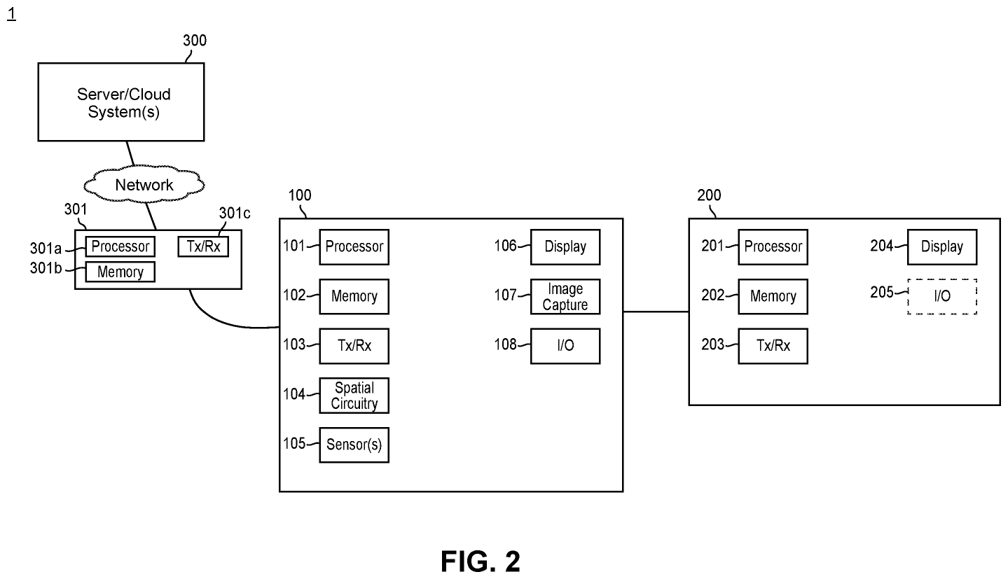

FIG. 2 shows a non-limiting example block diagram of components included in system 1. In the example shown in FIG. 2, the various components are in communication with each other (either directly or indirectly) while FIG. 2 depicts a specific communication arrangement. It should be appreciated that the arrangement shown in FIG. 2 is non-limiting and the technology describes any variety of methods in which the components can communicate with each other. Likewise, certain components in FIG. 2 are shown for exemplary purposes but may also be omitted in actual implementation. For example, mobile device 100 and/or display device 200 could communicate with system(s) 300 without base station(s) 301. It should be appreciated that the components can communicate with each other using a variety of methods (e.g., wired connection, wireless connection). In one non-limiting example embodiment, the components will communicate with each other over a network (not shown), over short distance communication (e.g., infrared, Bluetooth), or some combination thereof.

As shown in FIG. 2, system 1 includes a server/cloud system(s) 300 communicating with moving apparatus 100 via base station(s) 301, where moving apparatus 100 is in communication with display device 200. Base station(s) 301 include certain components for conducting communication between devices and can include, at least, processor 301a, memory 301b, and/or transceiver 301c.

Processor 301a could include, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, a graphic processing unit (GPU), or a system-on-a-chip (SOC) (e.g., an integrated circuit that includes a CPU and other hardware components such as memory, networking interfaces, and the like). And/or, in some embodiments, each or any of the processor 301a uses an instruction set architecture such as x86 or Advanced RISC Machine (ARM).

In some embodiments, each or any of memory 301b includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), a read only memory (ROM), or other type of device that performs the volatile or non-volatile storage of data and/or instructions (e.g., software that is executed on or by processors 301a).

In certain embodiments, each or any of the transceiver 301c includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers 301c may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

Moving apparatus 100 may include an on-board computer system (e.g., on-board telemetry system) that collects inputs associated with apparatus 100, processes the inputs, and then communicates output between display device 200 and/or system(s) 300. In one non-limiting example embodiment, apparatus 100 can include any of processor 101, memory 102, transceiver 103, spatial circuitry 104, sensor(s) 105, display 106, image capture 107 device(s), and/or various other input/output 108 device(s). In certain example embodiments, some components may be required by apparatus 100 while others may be optional. For example, apparatus 100 may optionally include display 106 and/or image capture 107 while maintaining the other various components.

In certain example embodiments, processor 101 could include, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, a graphic processing unit (GPU), or a system-on-a-chip (SOC) (e.g., an integrated circuit that includes a CPU and other hardware components such as memory, networking interfaces, and the like). And/or, in some embodiments, each or any of the processor 101 uses an instruction set architecture such as x86 or Advanced RISC Machine (ARM).

In some embodiments, memory 102 includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), a read only memory (ROM), or other type of device that performs the volatile or non-volatile storage of data and/or instructions (e.g., software that is executed on or by processors discussed herein).

In some embodiments, transceiver 103 could include one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers 103 may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

Spatial circuitry 104 could include one or more devices for determining the position, location, and/or orientation of moving apparatus 100. For example, spatial circuitry 104 could include a global position system (GPS) chipset, which may be configured to provide location information (e.g., longitude and latitude coordinate data) regarding the current location of apparatus 100. Spatial circuitry 104 could also include inertial sensing components (e.g., Micro Electro Mechanical Systems (MEMS)) including, but not limited to, accelerometer(s), gyroscope(s), and/or magnetometers. Spatial circuitry 104 could also include a compass to determine which direction moving apparatus 100 is current facing.

In certain example embodiments, sensor(s) 105 could include various sensors for detecting the operating state of moving apparatus 100. For example, sensor(s) 105 could obtain various telematics data associated with moving apparatus, which is not currently obtained by other components of apparatus 100 (e.g., spatial circuitry 104). For example, telematics data may be generated by and/or received from sensor(s) 105 associated with the apparatus 100. Such telematics data from the sensor(s) 105 may provide data regarding the apparatus 100 and/or its environment. Using the example of a lawn mowing device, sensor(s) 105 could provide data regarding the operating state of various blade decks and/or reels of the mower. In one example embodiment, sensor(s) 105 may also report a height of different blades as well as which blades and/or reels are currently active. These examples are of course non-limiting and sensor(s) 105 could report any other variety of data including, but not limited to, moving speed of apparatus 100, fuel (or battery) amount remaining in apparatus 100, status of various components in apparatus 100 (e.g., status of exterior lighting, status of certain electrical components), and/or steering direction of apparatus 100.

Sensor(s) 105 may also include devices (e.g., radar, LIDAR, ultrasonic, infrared, and/or camera units) that actively or passively scan the apparatus 100 environment for objects (e.g., other vehicles, buildings, pedestrians, etc.), traffic control elements (e.g., lane markings, signs, signals, etc.), external conditions (e.g., weather conditions, traffic conditions, road conditions, etc.), and/or other physical characteristics of the environment. Other sensor(s) 105 may be directed to the interior (or any passenger compartment) of apparatus 100, such as cameras, microphones, pressure sensors, thermometers, or similar sensors to monitor the apparatus 100 operator and/or passengers within the apparatus 100. These examples are of course non-limiting and the technology described herein envisions any variety of sensor(s) 105 that could be used for determining various operating states of apparatus 100.

In certain example embodiments, display 106 could include one or more circuits that receive data from the processors 101, generate (e.g., via a discrete GPU, an integrated GPU, a CPU executing graphical processing, or the like) corresponding image data based on the received data, and/or output (e.g., a High-Definition Multimedia Interface (HDMI), a DisplayPort Interface, a Video Graphics Array (VGA) interface, a Digital Video Interface (DVI), or the like), the generated image data to the display device 106, which displays the image data. Alternatively or additionally, in some embodiments, each or any of the display devices 106 is or includes, for example, a video card, video adapter, or graphics processing unit (GPU). Moreover, display 106 could generate image data that is then communicated to display device 200 (e.g., via a user interface or some other display).

It should be appreciated that display 106 may only generate the image data, or display 106 could alternately (or also) display the image data using components of moving apparatus 100. For example, display 106 could also include a Liquid Crystal Display (LCD) display, Light Emitting Diode (LED) display, or other type of display device. The display device 106 may also be a touchscreen display or non-touchscreen display.

In certain example embodiments, image capture device(s) 107 could include one or more components for capturing, storing, and/or processing image/video data. In some example embodiments, image capture device(s) 107 could also be equipped with components to additional capture audio data. For example, image capture device(s) 107 could include one or more cameras for recording and processing image (or moving image) data obtained in conjunction with operating apparatus 100. The data obtained by image capture device(s) 107 could be used by processor 101 for various different processing including, at least, image recognition processing to determine objects within a path of apparatus 100. Using the example of a mowing device, data obtained from image capture device(s) 107 could be used to additionally identify different hazards in front of (or near) apparatus 100 using different image processing techniques in order to aid in operation of apparatus 100. These examples are of course non-limiting and the technology described herein envisions any variety of mechanisms for obtaining and processing image data using image capture device(s) 107.

In some example embodiments, input/output 108 interface can include one or more circuits that receive and process user input data from one or more user input devices (not shown) that are included in, attached to, or otherwise in communication with the moving apparatus 100, and that output data based on the received input data to the processors 101. Alternatively or additionally, in some embodiments each or any of the input/output 108 interface is or includes, for example, a PS/2 interface, a USB interface, a touchscreen controller, or the like; and/or the input/output 108 interface facilitates input from user input devices (not shown) such as, for example, a keyboard, mouse, trackpad, touchscreen, etc. It should be appreciated that moving apparatus 100 has been described in association with a moving vehicle having an on-board computer. However, this example is of course non-limiting and the technology described herein envisions any type of mechanism for which moving apparatus 100 may obtain and process data. For example, moving apparatus 100 could be in the form of a computer, smart phone, and/or tablet.

Display device 200 could include various components for generating an audio/visual display. In one example embodiment, display device 200 could generate a display presented an augmented reality environment where portions of a real-world image are displayed in conjunction with a virtual environment (e.g., including one or more virtual objects). Display device 200 could include processor 201, memory 202, transceiver 203, display 204, and/or input/output interface 205.

In certain example embodiments, processor 201 could include, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, a graphic processing unit (GPU), or a system-on-a-chip (SOC) (e.g., an integrated circuit that includes a CPU and other hardware components such as memory, networking interfaces, and the like). And/or, in some embodiments, each or any of the processor 201 uses an instruction set architecture such as x86 or Advanced RISC Machine (ARM).

In some example embodiments, memory 202 could include a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), a read only memory (ROM), or other type of device that performs the volatile or non-volatile storage of data and/or instructions (e.g., software that is executed on or by processors discussed herein).

In various example embodiments, transceiver 203 could include one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers 203 may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In some example embodiments, display 204 can obtain image data from moving apparatus 100 for output using display device 200. For example, display 204 could include one or more circuits that receive data from the processors 201, generate (e.g., via a discrete GPU, an integrated GPU, a CPU executing graphical processing, or the like) corresponding image data based on the received data, and/or output (e.g., a High-Definition Multimedia Interface (HDMI), a DisplayPort Interface, a Video Graphics Array (VGA) interface, a Digital Video Interface (DVI), or the like), the generated image data to the display device 204, which displays the image data. Alternatively or additionally, in some embodiments, each or any of the display devices 204 is or includes, for example, a video card, video adapter, or graphics processing unit (GPU).

Moreover, display 204 could include the physical components for outputting the image data, as discussed herein. That is, display 204 could include a Liquid Crystal Display (LCD) display, Light Emitting Diode (LED) display, or other type of display device. The display 204 may also be a touchscreen display or non-touchscreen display. It should be appreciated that display 204 may have a transparent or translucent medium through which light representative of images is directed to a user's eyes. The display 204 may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. Display device 200 can also include an optical subassembly configured to help optically adjust and correctly project the image-based content being displayed by the display 204 for close up viewing. The optical subassembly can include one or more lenses, mirrors, or other optical devices.

In some embodiments, input/output interface 205 can include various input and/or output components used in conjunction with other components of display device 200. For example, input/output interface 205 could include one or more cameras for capturing a view of an external environment, as described herein. The view captured by the camera(s) can be presented by the display 204 or otherwise analyzed to provide a basis for an output on the display 204. Moreover, input/output interface 205 can include any other various devices including, but not limited to, audio/video jacks, data connectors, microphone(s), and/or speaker(s). These examples are of course non-limiting and the technology described herein envisions any variety of components that can be used for obtaining input and providing output in association with display device 200 and/or system 1.

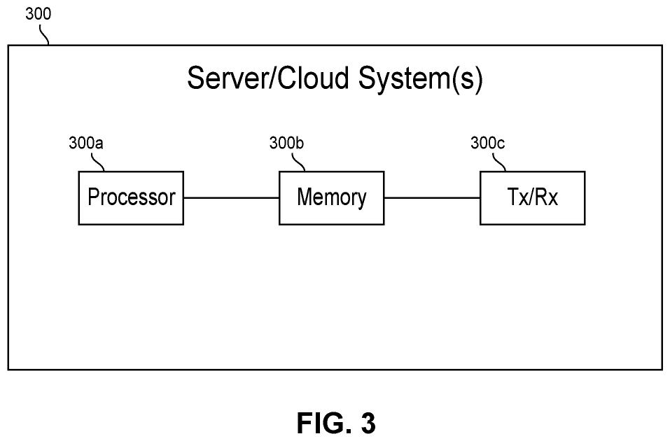

FIG. 3 shows a non-limiting example block diagram of components included in server/cloud system(s) 300. It should be appreciated that server/cloud system(s) 300 could be contained within a single system, or could be distributed across multiple systems. Moreover, system(s) 300 could be physically located near other components of system 1, or could be remotely located from the components of system 1 (e.g., communicating over a network). In one example embodiment, system(s) 300 could include processor 300a, memory 300b, and/or transceiver 300c. It should be appreciated that system(s) 300 may also obtain data from other components of system 1 (e.g., moving apparatus 100, display device 200) in order to process data for operating such devices. For example, system(s) 300 may generate various map data for determining a navigation “layout” for apparatus 100 and can generate various boundary points for establishing geo-fences for dividing a particular area into one or more sub-areas.

In some embodiments, processor 300a could include, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, a graphic processing unit (GPU), or a system-on-a-chip (SOC) (e.g., an integrated circuit that includes a CPU and other hardware components such as memory, networking interfaces, and the like). And/or, in some embodiments, each or any of the processor 300a uses an instruction set architecture such as x86 or Advanced RISC Machine (ARM).

In some embodiments, memory 300b includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), a read only memory (ROM), or other type of device that performs the volatile or non-volatile storage of data and/or instructions (e.g., software that is executed on or by processors discussed herein).

In some embodiments, transceiver 300c could include one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers 300c may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In various embodiments, the system(s) 300 includes one, two, three, four, or more of each or any of the above-mentioned elements (e.g., the processors 300a, memory devices 300b, transceivers 300c). Alternatively or additionally, in some embodiments, the system(s) 300 includes one or more of: a processing system that includes the processors 300a; a memory or storage system that includes the memory devices 300b; and a network interface system that includes the transceivers 300c.

The system(s) 300 may be arranged, in various embodiments, in many different ways. As just one example, the server/cloud system 300 may be arranged such that the processors 300a include: a multi (or single)-core processor; a first network interface device (which implements, for example, WiFi, Bluetooth, NFC, etc. . . . ); a second network interface device that implements one or more cellular communication technologies (e.g., 3G, 4G LTE, CDMA, etc. . . . ); memory or storage devices (e.g., RAM, flash memory, or a hard disk). The processor, the first network interface device, the second network interface device, and the memory devices may be integrated as part of the same SOC (e.g., one integrated circuit chip). As another example, the system 300 may be arranged such that: the processors 300a include two, three, four, five, or more multi-core processors; the transceivers 300c include a first network interface device that implements Ethernet and a second network interface device that implements WiFi and/or Bluetooth; and the memory 300b include a RAM and a flash memory or hard disk.

The hardware configurations shown in FIG. 3 and described above are provided as examples, and the subject matter described herein may be utilized in conjunction with a variety of different hardware architectures and elements. For example: in many of the Figures in this document, individual functional/action blocks are shown; in various embodiments, the functions of those blocks may be implemented using (a) individual hardware circuits, (b) using an application specific integrated circuit (ASIC) specifically configured to perform the described functions/actions, (c) using one or more digital signal processors (DSPs) specifically configured to perform the described functions/actions, (d) using the hardware configuration described above with reference to FIGS. 2 and 3, (e) via other hardware arrangements, architectures, and configurations, and/or via combinations of the technology described in (a) through (e).

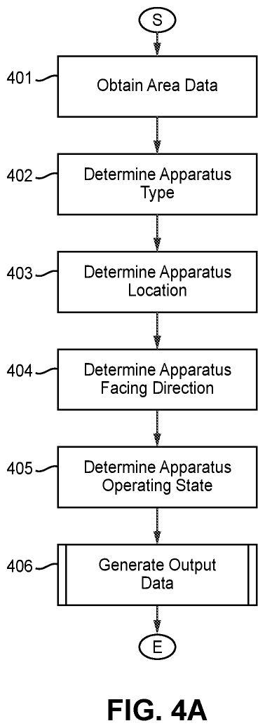

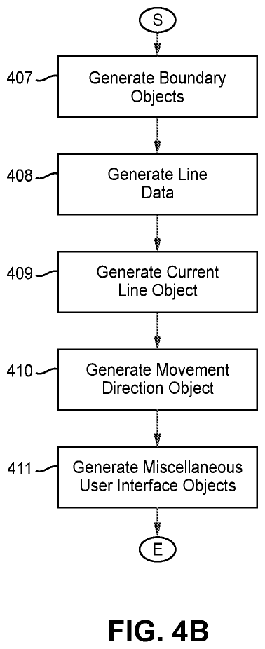

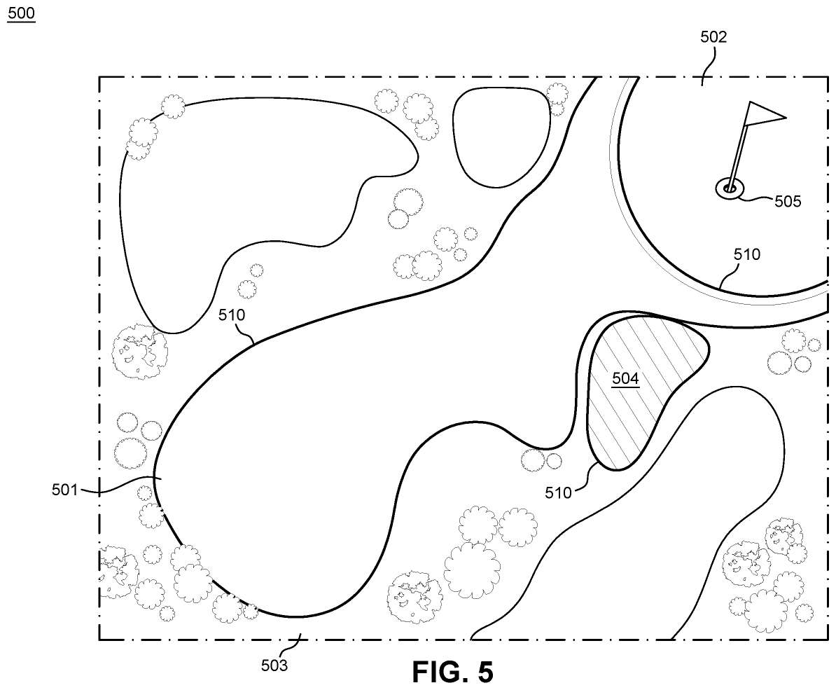

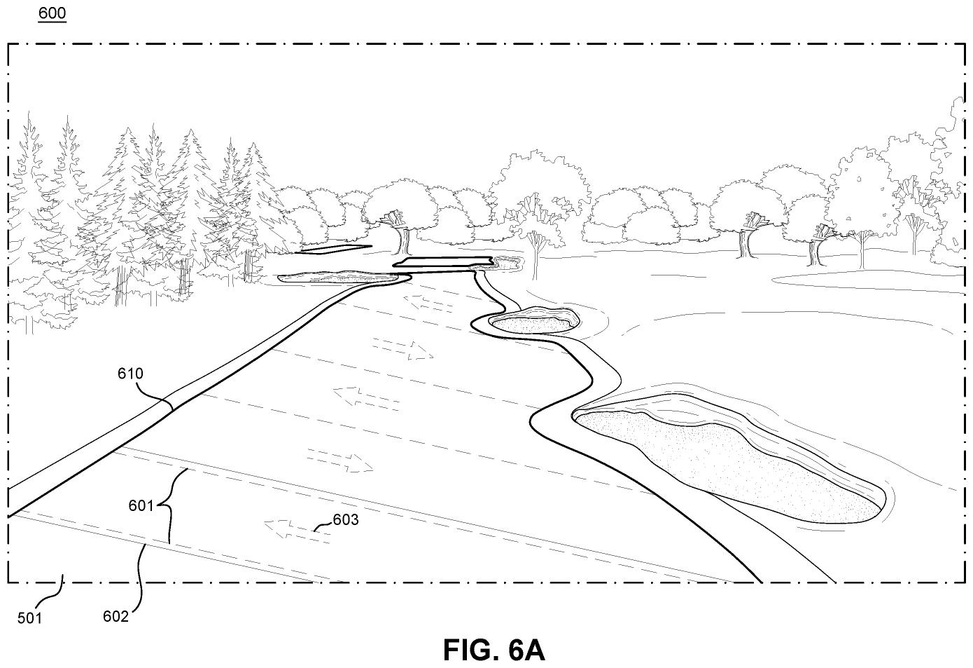

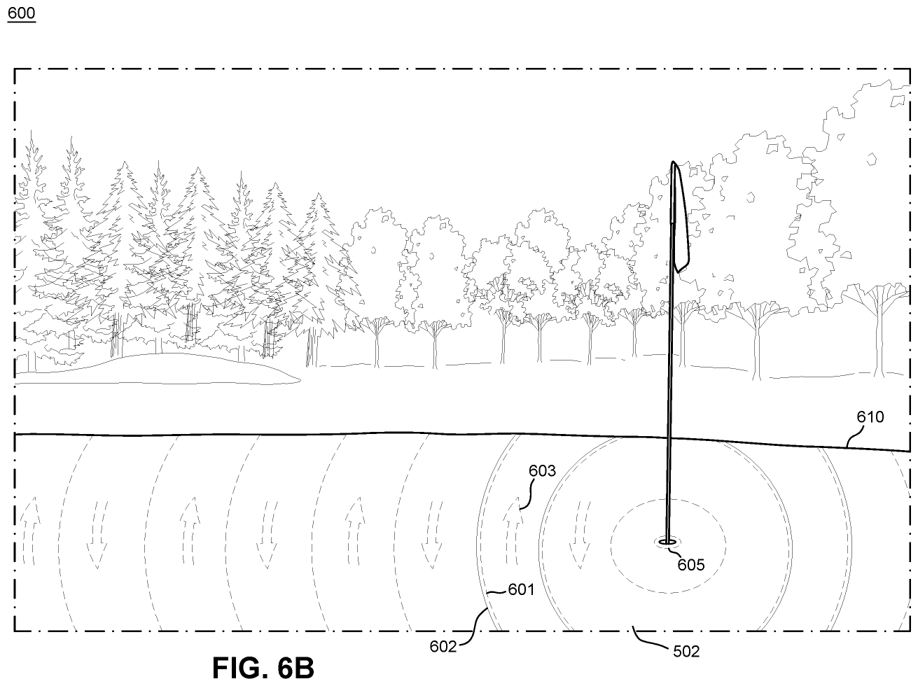

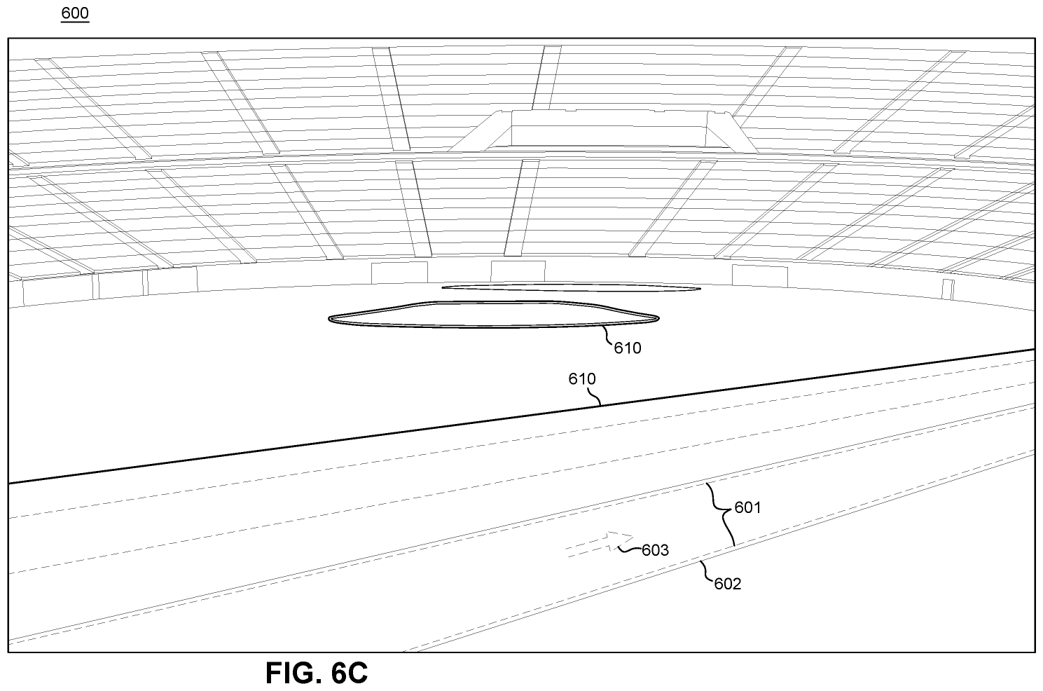

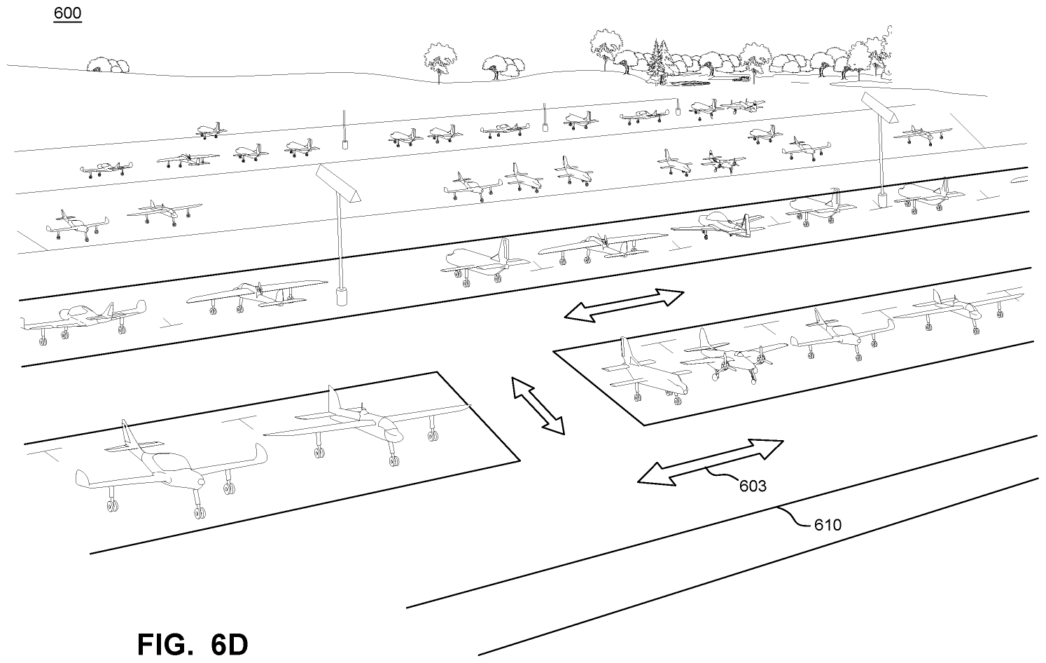

FIGS. 4A and 4B show non-limiting example processes associated with system 1. In particular, FIGS. 4A and 4B show non-limiting example flowcharts associated with processes for generating output data (e.g., augmented reality audio/video data) by system 1. FIGS. 5, 6A, and 6B also depict various non-limiting embodiments associated with the processes described in association with FIGS. 4A and 4B. For example, FIG. 5 shows an “overhead” view showing a location with different sub-areas divided by one or more geofenced barriers. FIGS. 6A and 6B show a non-limiting example user interface 600 generated by system 1. In the examples described herein, user interface 600 may be generated as an augmented reality image (that can include audio output) showing different virtual objects overlaid over a “real-world” image. Of course, such an example is non-limiting and the user interface 600 can be displayed via any variety of means including, but not limited to, a regular display, a virtual reality display, a holographic display, and/or a projector display.

FIG. 4A particularly shows a non-limiting example embodiment of processes associated with determining how to generate the output data, while FIG. 4B shows a non-limiting example embodiment of processes associated with generating the actual output data. It should be appreciated that the steps carried out in FIGS. 4A and 4B can be implemented by various components within system 1. In one non-limiting example embodiment, certain steps may be implemented via apparatus 100, display device 200, and/or system(s) 300.

The process begins (at step 401) where system 1 can obtain area data associated with a location (e.g., a “real-world” geographical location). FIG. 5 shows an example area 500 associated with a geographical location where a non-limiting example golf course is illustrated. While a golf course is used in an example embodiment, it should be appreciated that the technology is not limited to such an environment and the technology described herein can be used in association with any real (or even virtual) location/area.

Using the example from FIG. 5, the area data includes one or more boundaries 510 separating area 500 into one or more sub-areas 501-504. Moreover, area data may include other area objects 505 highlighted for a user. For example, object 505 could include an item (or small area) that is highlightable to a user so that the user is aware of an item (or area) associated with object 505. As a non-limiting example, area objects 505 could include items that an operate of a mowing device, for example, should avoid (e.g., sprinkler heads, holes, tee markers).

It should be appreciated that boundaries 510 may be established using geofencing techniques. In one example embodiment, system 1 can use the Global Positioning System (GPS), radio frequency identification (RFID), Wi-Fi, cellular data (or any other mechanism) to define a virtual geographical boundary 510 and trigger a targeted action when a device enters or exits that boundary 510. It should be appreciated that the virtual boundaries 510 (or geofences) can be active or passive. Active geofences may require an end user to opt-in to location services, while passive geofences may be “always on” (e.g., they rely on Wi-Fi and cellular data, and work in the background).

As discussed herein, boundaries 510 separate area 500 into one or more sub-areas 501-504. Using example of a golf course, sub-area 501 could include a “fairway,” sub-area 502 could include a “green,” sub-area 503 could include a “rough” area, while sub-area 504 could include a “sand trap” area. The boundaries 510 shown in FIG. 5 are merely illustrative and the geofencing may be employed in any variety of ways and/or shapes. For example, the geofenced boundaries 510 in FIG. 5 are depicted as forming boundaries 510 along outlines of different elements of a golf course when the boundaries 510 may be more simplistic shapes (e.g., circles, squares, rectangles, triangles).

In any case, boundaries 510 can separate different geographical locations so that different triggering events may occur depending upon a user's proximity within a particular sub-area. In the example of a user operating mowing equipment, the user may be maneuvering the mower in a “rough” sub-area 503. In order to prevent different parts of the golf course from incurring damage (or an uneven “cut), an alert may be presented to the user (e.g., via display 200) when the user enters into another sub-area (e.g., moving into fairway sub-area 501). An alert is of course just a non-limiting example and the system 1 can produce any type of triggering event including, but not limited to, disabling the moving apparatus 100 and/or disabling/enabling portions of moving apparatus 200 (e.g., disabling mowing blades, mowing reels, tires, enabling brakes).

Upon obtaining the area data, system 1 may determine an apparatus type (at action 402). Using the example of mowing equipment on a golf course, system 1 may determine a type of mowing equipment being used. For example, mowing equipment (embodied, for example, by moving apparatus 100) may include a “walking” mower, a “riding” mower, a “reel” mower, and/or any other type of device used to maintain a portion of landscape. If the user is operating a “riding” mower (e.g., with or without a reel assembly), system 1 may determine that certain areas are restricted for such a piece of equipment to enter. For example, a “riding” mower may be restricted from entering the “green” sub-area 502 or “sand trap” sub-area 504 in order to both avoid damaging the mower (or injuring the operator) and avoid damaging the terrain.

In order to understand whether apparatus 100 is within an acceptable area, system 1 (at action 403) may determine a location of apparatus 100. In one example embodiment, system 1 may obtain GPS location data (e.g., using data output from spatial circuitry 104) of apparatus 100 to determine a latitude and longitude coordinate value associated with the location of apparatus 100. Based on the GPS location data, system 1 can understand where apparatus 100 is physically located within area 500. It should be appreciated that system 1 may alternatively (or additionally) understand the location of apparatus 100 using any other mechanism. For example, system 1 may triangulate the location of apparatus 100 based on proximity to one or more base stations 301-304.

System 1 (at action 404) may determine the facing direction of apparatus 100. In one non-limiting example embodiment, system 1 may use compass data to determine which direction apparatus 100 currently faces. Compass data may be output, for example, using spatial circuitry 104 of apparatus 100. This example is of course non-limiting and system 1 can use any variety of methods for determining a facing direction of apparatus 100. For example, system 1 may employ image capture and recognition techniques (e.g., used in conjunction with image capture 107 and/or sensor(s) 105) to identify various objects within an image and understand which direction apparatus 100 is facing based on the recognition.

System 1 (at action 405) may determine an operating state of apparatus 100. Using the example of mowing equipment, system 1 may determine different aspects of operation associated with a mower that include, but are not limited to, a moving speed of the mower, whether the mower blades are active, whether certain mower reels (or blades) are active, a current height of the mower blade deck, whether the mower braking system is active, and/or a steering direction of the mower. In one non-limiting example embodiment system 1 can use data obtained from sensor(s) 105 (as well as any other component of apparatus 100 shown at least in FIG. 2) to determine the current operating state of different elements of the moving apparatus 100.

System 1 may (at action 406) generate various output data using the information obtained/determined at actions 401-405. In one example embodiment, system 1 may generate different user interface data (which can be output via display device 200) based on understanding the various information associated with moving apparatus 100. Alternatively (or additionally) system 1 may use such data to control apparatus 100. For example, if a mowing equipment is close to (or has) entering a restricted area, system 1 may disable apparatus 100 (or disable certain portions of apparatus 100). These examples are of course non-limiting and system 1 may use the information associated with apparatus 100 to perform any variety of actions. It should be further appreciated that while the techniques described herein are illustrated with respect to a golf course environment, the technology can be implemented in any setting. For example, the technology described herein can be used to direct various equipment within the interior or exterior of an airport terminal, or to direct various landscaping equipment for any other type of sporting venue (e.g., football field, baseball field, soccer field, ice hockey rink). The technology could also be used in any subterranean setting or in any aerial setting as well.

As noted herein, FIG. 4B shows a non-limiting example embodiment of processes associated with generating the actual output data. In one non-limiting example embodiment, the processes depicted in FIG. 4B are illustrated in the example user interface 600 shown in FIGS. 6A and 6B. System 1 (at action 407) may generate boundary objects 610 on user interface 600. Boundary objects 610 could include visual indicators identifying boundaries 510 of sub-areas 501-504 displayable via user interface 600. FIGS. 6A and 6B show boundary object 610 separating a golf course fairway and green, respectively, from a rough and sand trap area. The boundary objects 610 can be displayed as lines forming an outline of a particular sub-area, while areas outside the boundary of a sub-area may be displayed in a specific color (e.g., red) showing that the operator should maintain focus within a particular sub-area.

System 1 may (at action 408) generate line data displayable via user interface 600. In one example embodiment, the line data could be generated to instruct an operator to move within regions separated by displayed lines. FIGS. 6A and 6B show lines 601 displayed along the terrain that enable a user to understand a general pattern with which to move apparatus 100 within. In one example embodiment, lines 601 could be displayed to instruct a specific mow pattern for areas of a golf course (or any other terrain) in order to generate a landscape product that appears orderly and neat.

System 1 may (at action 409) generate current line data depicting on or more currently lines forming an area showing where apparatus 100 should currently stay within. Current line data may be shown as current lines 602 (shown in FIGS. 6A and 6B) where the current lines can be used to guide a user moving the moving apparatus 100 within a particular line boundary. For example, user interface 600 may generate lines 601 to show an overall mowing pattern within a particular area, where current line 602 can show where an operator must currently stay withing a particular moving direction of moving apparatus 100.

A moving direction object 603 may be generated (at action 410) by system 1. In one example embodiment, moving direction object 603 may visually indicate which direction moving apparatus 100 should move within an area formed between two or more current lines 602 (or between any two or more lines 601). In the example shown in FIGS. 6A and 6B, moving direction object 603 could be displayed as a direction indicator (e.g., arrows) showing which direction (e.g., north, south, east, west) the user should operate apparatus 100. As the user moves within various areas formed by lines 601 and 602 (and in the direction indicated by direction object 603), user interface 600 may generate further visual indication enabling the user to understand which areas have been “mowed” (or traveled through) and which areas require further “mowing” (or travel through). For example, areas that have been “mowed” using apparatus 100 may be “greyed out” or displayed in a different color (e.g., blue) to indicate that user should no longer operate apparatus 100 within that particular region. Likewise, interface 600 can display indication showing where user should continue to operate apparatus 100 (e.g., by displaying the “active” area another color). These examples are of course non-limiting and the technology described herein can provide any variety of indication including, but not limited to, displaying various areas as translucent and/or opaque depending upon whether a user has operated apparatus 100 within the particular area.

System 1 may (at action 411) generate other miscellaneous user interface objects displayable via user interface 600. For example, and as can be seen in FIG. 6B, system 1 may generate highlight object 605 highlighting an item (or area) where user should avoid operating apparatus 100. In the example shown in FIG. 6B, highlight object 605 highlights a golf course hole where user should avoid operating moving apparatus 100 near (or over). System 1 may generate any other variety of miscellaneous user interface objects including user interface elements that provide various “informational” items. For example, system 1 may generate a user interface element that includes a current time, a current temperature, a current direction in which the user is facing, current location information, and/or any other informational item.

System 1 may also generate user interface elements that highlight different operating states of apparatus 100. For example, certain user interface elements may be generated to indicate whether the braking system is activate, whether mower blades are activated, a current speed associated with apparatus 100, a current moving direction of apparatus 100, and/or a current state of other elements of apparatus 100 (e.g., current state of exterior/interior lighting, current state of different wheels of apparatus 100).

Moreover, system 1 could generate information indicating aspects of different areas within a particular sub-area. For example, system 1 could generate an indication along a “rough” area noting which areas may be more “dry” or more “wet” than others. For example, if a rain storm occurred recently, system 1 could generate a visual display via interface 600 indicating that a particular region may be too “wet” to mow. Likewise, if an area is more dry than others, system 1 could generate a visual display via interface 600 indicating that the particular region should not be cut as low if the grass in the region is too dry (i.e., an not growing as much as surrounding regions). These examples are of course non-limiting and the technology described herein envisions any variety of display objects and/or information displayable by system 1 in user interface 600.

Although actions 401-406 and 407-411 are shown in FIGS. 4A and 4B (respectively) as occurring once, these actions 401-406 and 407-411 may, in various embodiments, be repeated a number of times. Moreover, actions 401-406 and 407-411, while shown in separate flowcharts, can be combined together (e.g., as a single process) or divided into further sub-processes. Likewise, although actions 401-406 and 407-411 are shown in a specific order, it should be appreciated that in certain example embodiments, the steps in any action can be carried out in any order at any number of times.

FIG. 6C shows another non-limiting example user interface 600 where the technology is implemented with respect to a baseball field. In the example shown in FIG. 6C, the baseball field area near the pitching mound is highlighted. Similar to the techniques shown in association with FIGS. 6A and 6B, the system 1 can generate user interface 600 where boundaries 610 depict where a user can operate moving apparatus 200. For example, boundary 610 may encompass a portion (or all) of an infield area of a baseball diamond where lines 601 can show the desired mowing pattern. Similar to FIGS. 6A and 6B, current line 602 can be generated to show an operator an area to mow within a specific set of lines 601 and direction object 603 can indicate the direction in which to move. The example of FIG. 6C is of course non-limiting and user interface 600 can generate any various elements to display in association with operating moving apparatus 200 on the field.

FIG. 6D shows another non-limiting example user interface 600 where the technology is implemented with respect to an airport (or air field). In the example shown in FIG. 6D, the airport general runway and outside area where planes and equipment are shown. Similar to the techniques shown in association with FIGS. 6A-C, system 1 can generate user interface 600 where boundaries 610 depict where a user can operate moving apparatus 200. In the example shown in FIG. 6D, user interface 600 is intended to highlight a general area of movement for apparatus 600 and thus less user interface elements may be displayed (e.g., as the user is not “mowing” a particular area). For example, user interface 600 can display boundaries 610 highlighting the driving paths that avoid entering areas where aircraft (or other vehicles) may be positioned and/or moving. For example, boundaries 610 can prohibit the user from moving into a runway for an airplane. User interface 600 can also display direction object(s) 603 indicating which directions the user can move within boundaries 610. These examples are of course non-limiting and user interface 600 can generate any various elements to display in association with operating moving apparatus 200.

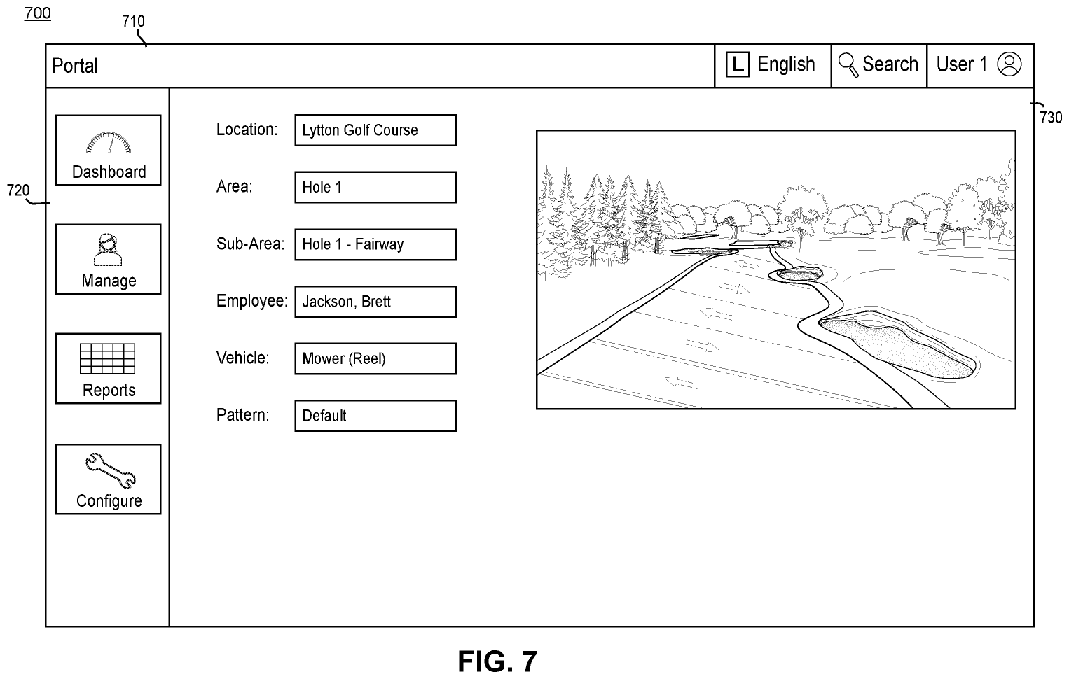

FIG. 7 shows a non-limiting example portal (or user interface) 700 where elements associated with system 1 can be accessed. In one non-limiting example embodiment, portal 700 can include a web-based (or application-based) portal where a user can perform various tasks associated with administration and/or use of system 1. As a non-limiting example, portal 700 can allow a user to view data, perform analysis, administer, and/or configure aspects associated with system 1.

Portal 700 can include several components of the user interface including a header portion 710, a side menu portion 720, and a body portion 730. These examples are of course non-limiting and portal 700 can display a user interface in any manner including less or more of the components shown herein. For example, portal 700 may only display a user interface with a header portion 710 and a body portion 730 (i.e., excluding any side menu portion 720).

Header portion 710 can include, in an example embodiment, various elements associated with general navigation and customization of portal 700. In the example shown in FIG. 7, header portion 710 includes elements for changing language settings, performing a search operation, and/or selecting options associated with a user operating portal 700. These examples are of course non-limiting and header portion 710 can include any items associated with general navigation and use of portal 700.

Side menu portion 720 can include various elements associated with navigating specific views of portal 700. In one example embodiment, portal 700 can include a plurality of views where each view may be associated with a specific application (or sub-application) of portal 700. In the example shown in FIG. 7, portal 700 includes a dashboard view, a manage view, a reports view, and a configure view, where each view includes associated selectable items within side menu portion 720.

Selection of different items in side menu portion 720 can result in portal 700 populating body portion 730 with content associated with a specific view. For example, selection of dashboard view could result in body portion 730 including a general user interface dashboard showing general overview items associated with portal 700 and system 1. The dashboard view could include general summary information and/or basic messages or informational elements related to operation of system 1. A reports view could show different detailed reports and analysis of users operating system 1. For example, the reports view could show different graphs, histograms, and/or a visualization that provides analysis of different employee performance for providing care of a field or course. The configure view could display various information associated with configuring (or administering) system 1. For example, the configure view could display information associated with user account configuration, employee assignment information, and/or equipment configuration.

The example shown in FIG. 7 depicts the manage view as being highlighted in side menu portion 720 where content associated with the manage view are shown in body portion 730. In one example embodiment, manage view can depict different information for an employee (e.g., manager) to select and assign various elements associated with a location. In the example shown in FIG. 7, the manage view allows a manager to select information associated with different golf courses where various options for each course can be selected. For example, an employee may select a course associated with a location where options for selecting an area (e.g., a hole) and sub-area (e.g., rough, fairway, green) of the area can be further selected. Manage view can also include an element for selecting a particular employee (e.g., to mow an area or sub-area for a hole) where a vehicle type (e.g., mower type) and/or pattern can be selected. Manage view may also include an image window where the area (or sub-area) can be shown and elements associated with the pattern may be displayed in a reduced size. These examples are of course non-limiting, and the technology described herein can display any various type of information within the user interface of portal 700.

The portal 700 can further include a configure view where an administrator may configure various aspects associated with the system. For example, in the configure view, the administrator can log into to define and configure the geofences, work areas, and other relevant parameters that are processed and used to generate the visual UI data displayed by the glasses. In one example embodiment, the portal 700 could allow the administrator to enter inputs (e.g., via an input device, touch sensitive display) to set the different boundaries for the geofenced regions and to define the different regions (e.g., fairway, green, rough) so that the proper data is conveyed to the display device 200. These examples are of course non-limiting and the portal 700 can display any variety of information for configuring the system.

It should be further appreciated that the portal 700 may be made available to a user (or entity) as part of a subscription (e.g., monthly, yearly) to access the portal 700. That is, an individual (or company) may pay a recurring fee to access the portal 700 where portal 700 may be maintained and updated over time. This example is of course non-limiting and system 1 could include free tier(s) of features and level(s) of subscription(s) (or subscriptions on a feature-by-feature basis).

### Technical Advantages of Described Subject Matter

The technology described herein provides an improved augmented reality system by linking an augmented reality user interface with specific location data to guide a user to navigate at the location. In particular, the technology allows for the system to, among other aspects, determine boundaries associated with a location and generate a “layout” within the boundaries where a graphical user interface can be overlaid over a real word image using an augmented reality display. The boundaries may be generated using geofencing technology where the geofences are associated with a specific coordinate area. The technology thus advantageously provides an improved augmented reality user interface compared to conventional technology thus improving the overall human-computer interface.

### Further Applications of Described Subject Matter

As used in this document, the term “non-transitory computer-readable storage medium” includes a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVD, or Blu-Ray Disc, or other type of device for non-transitory electronic data storage.

As used in this document, the term “and/or” includes any and all combinations of one or more of the associated listed items.

In the following description, for purposes of explanation and non-limitation, specific details are set forth, such as particular nodes, functional entities, techniques, protocols, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail.

Whenever it is described in this document that a given item is present in “some embodiments,” “various embodiments,” “certain embodiments,” “certain example embodiments, “some example embodiments,” “an exemplary embodiment,” or whenever any other similar language is used, it should be understood that the given item is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments. Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an” and “the” should be read as meaning “at least one,” “one or more,” or the like; the term “example” is used provide examples of the subject under discussion, not an exhaustive or limiting list thereof; the terms “comprise” and “include” (and other conjugations and other variations thereof) specify the presence of the associated listed items but do not preclude the presence or addition of one or more other items; and if an item is described as “optional,” such description should not be understood to indicate that other items are also not optional.

Although process steps, algorithms or the like, including without limitation with reference to any of the figures, may be described or claimed in a particular sequential order, such processes may be configured to work in different orders. In other words, any sequence or order of steps that may be explicitly described or claimed in this document does not necessarily indicate a requirement that the steps be performed in that order; rather, the steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

Although various embodiments have been shown and described in detail, the claims are not limited to any particular embodiment or example. None of the above description should be read as implying that any particular element, step, range, or function is essential. All structural and functional equivalents to the elements of the above-described embodiments that are known to those of ordinary skill in the art are expressly incorporated herein by reference and are intended to be encompassed

While the technology has been described in connection with what is presently considered to be an illustrative practical and preferred embodiment, it is to be understood that the technology is not to be limited to the disclosed embodiment, but on the contrary, is intended to cover various modifications and equivalent arrangements.

1. A system, comprising:
a movable apparatus configured to be operated by a user, the movable apparatus having processing circuitry including at least a processor and a memory; and
a display device configured to be worn by the user, wherein
the processing circuitry of the movable apparatus is configured to:
obtain area data associated with a geographical area of a real-world location, wherein the area data includes a plurality of sub-areas separated by geofenced boundaries;
determine a location of the movable apparatus within the geographical area of the real-world location;
determine a facing direction of the movable apparatus, wherein the facing direction is associated with a direction a front of the movable apparatus is currently facing;
determine an operating state of the movable apparatus;
generate media data using the location, the facing direction, and the operating state of the movable apparatus, wherein the media data includes:
boundary objects associated with the geofenced boundaries separating the plurality of sub-areas,
line data indicating movable areas for the movable apparatus to move within a sub-area of the plurality of sub-areas,
current line data indicating a current area for the movable apparatus to move within the movable areas, and
direction indication information indicating a current moving direction of the movable apparatus; and
communicate the media data to the display device, and
the display device is configured to:
obtain the media data from the processing circuitry of the movable apparatus; and
output the media data.

2. The system of claim 1, wherein the processing circuitry of the movable apparatus is further configured to:
determine a moving amount of the movable apparatus;
update the media data based on the moving amount, the location, the facing direction, and the operating state of the movable apparatus; and
communicate the updated media data to the display device.

3. The system of claim 1, wherein the area data includes a plurality of markers indicating specific objects located in each of the plurality of sub-areas.

4. The system of claim 1, wherein the location of the movable apparatus is determined using global position system (GPS) coordinate data.

5. The system of claim 1, wherein the facing direction is determined using compass data.

6. The system of claim 1, wherein the facing direction of the movable apparatus is determined using image processing data obtained by the movable apparatus.

7. The system of claim 1, wherein the operating state of the movable apparatus includes a current height of mower blades of the movable apparatus, and whether the mower blades of the movable apparatus are active.

8. The system of claim 7, wherein the operating state of the movable apparatus further includes indication of whether certain reels of the movable apparatus are active.

9. The system of claim 1, wherein
the display device includes glasses configured to generate audio and visual output to the user, and
the movable apparatus includes a mowing device configured to mow a terrain.

10. The system of claim 1, further comprising:
a plurality of base stations, wherein
the location of the movable apparatus is determined using triangulation techniques based on a position of the movable apparatus with respect to some of the plurality of base stations.

11. A method for generating media data usable in an augmented reality environment, the method comprising:
obtaining area data associated with a geographical area of a real-world location, wherein the area data includes a plurality of sub-areas separated by geofenced boundaries;
determining a location of a movable apparatus within the geographical area of the real-world location;
determining a facing direction of the movable apparatus;
determining an operating state of the movable apparatus;
generating media data using the location, the facing direction, and the operating state of the movable apparatus, wherein the media data includes:
line data indicating movable areas for the movable apparatus to move within a sub-area of the plurality of sub-areas, and
direction indication information indicating a current moving direction of the movable apparatus; and
generating, for display, the media data using a display device.

12. The method of claim 11, wherein the media data further includes:
boundary objects associated with the geofenced boundaries separating the plurality of sub-areas, and
current line data indicating a current area for the movable apparatus to move within the movable areas.

13. The method of claim 11, further comprising:
determining a moving amount of the movable apparatus; and
updating the media data based on the moving amount, the location, the facing direction, and the operating state of the movable apparatus.

14. The method of claim 11, wherein the area data includes a plurality of markers indicating specific objects located in each of the plurality of sub-areas.

15. The method of claim 11, wherein
the location of the movable apparatus is determined using global position system (GPS) coordinate data, and
the facing direction is determined using compass data.

16. A display apparatus, comprising:
processing circuitry including at least a processor and a memory; and
a display device configured to output audio and video data, wherein the processing circuitry is configured to:
obtain area data associated with a geographical area of a real-world location, wherein the area data includes a plurality of sub-areas separated by geofenced boundaries;
determine a location of a movable apparatus within the geographical area of the real-world location;
determine an operating state of the movable apparatus;
generate media data using the location and the operating state of the movable apparatus, wherein the media data includes:
line data indicating movable areas for the movable apparatus to move within a sub-area of the plurality of sub-areas, and
direction indication information indicating a current moving direction of the movable apparatus; and
output the media data using the display device.

17. The display apparatus of claim 16, wherein the processing circuitry is further configured to:
determine a facing direction of the movable apparatus; and
generate the media data using the location, the facing direction, and the operating state of the movable apparatus.

18. The display apparatus of claim 16, wherein the media data further includes:
boundary objects associated with the geofenced boundaries separating the plurality of sub-areas, and
current line data indicating a current area for the movable apparatus to move within the movable areas.

19. The display apparatus of claim 16, wherein the processing circuitry is further configured to:
determine a moving amount of the movable apparatus;
update the media data based on the moving amount, the location, and the operating state of the movable apparatus; and
output the updated media data using the display device.

20. The display apparatus of claim 16, wherein the area data includes a plurality of markers indicating specific objects located in each of the plurality of sub-areas.
